(19) United States
(12) Patent Application Publication
(10) Pub. No.: US 2008/0257667 A1
(43) Pub. Date: Oct. 23, 2008

(54) Device For Decoupling an Attachment From a Moving Machine Element

(75) Inventors: Jens Hamann, Furth (DE); Alexander Kubik, Erlangen (DE); Uwe Ladra, Erlangen (DE); Elmar Schafers, Nurnberg (DE); Dietmar Stoiber, Furth (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/572,670

(22) PCT Filed: Jul. 25, 2005
(86) PCT No.: PCT/EP05/53604

§ 371 Date: Jan. 25, 2007

(30) Foreign Application Priority Data
Jul. 29, 2004 (DE) 10 2004 036 796.5

(51) Int. Cl. F16D 63/00

(52) U.S. Cl. 188/267

(57) ABSTRACT

The invention relates to a device for decoupling an attachment (7a, 7b, 7c, 7d) from a moving machine element (4) of a machine tool, production machine or of a robot. In order to carry out the decoupling, the attachment (7a, 7b, 7c, 7d) is joined to the machine element (4) via a damping device (13). The invention provides a simple device for decoupling an attachment from a moving machine element of a machine tool, production machine or of a robot.

The invention relates to a device for decoupling an attachment from a moving machine element of a machine tool, a production machine or a robot.

In machine tools, production machines or robots, “attachments” are attached to moving machine elements, such as a tool slide or a robot arm for example.

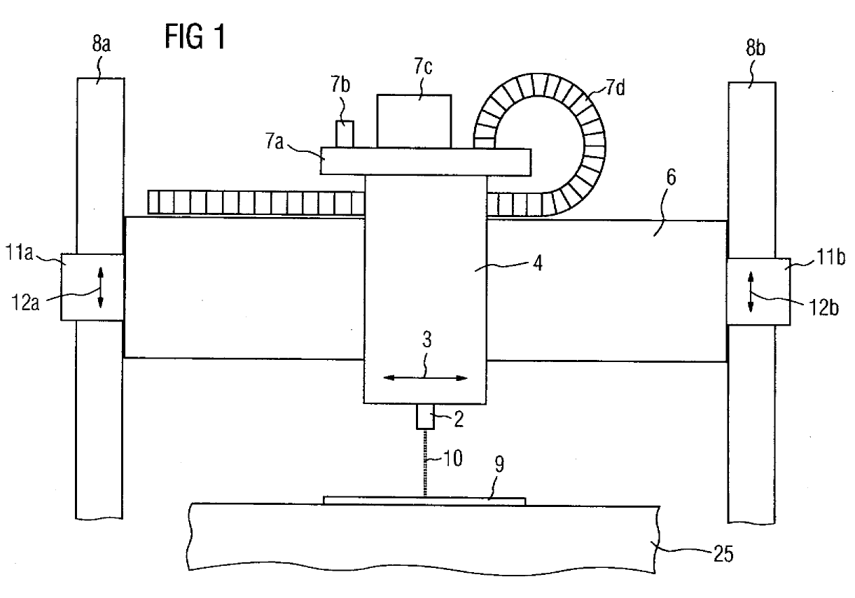

A machine tool in the form of a laser cutting machine is shown by way of example in FIG. 1. The machine tool has a crosspiece 6, which can be moved up and down along the columns 8a and 8b in both directions of the double arrows 12a and 12b by means of two drives 11a and 11b. The crosspiece 6 has a moving machine element 4 in the form of a tool slide, which can be moved along the crosspiece 6 in both directions of the double arrow 3 by means of a drive (not shown) which is located inside the tool slide. The tool slide carries a tool 2 which generates a laser beam 10, which strikes a workpiece 9, which may be in the form of a metal sheet for example, and machines the latter. The workpiece 9 is mounted on a machine bed 10. The tool slide is connected directly or indirectly to attachments, which in the machine tool shown by way of example are in the form of a support plate 7a, a valve 7b, a hydraulic component 7c and a trailing cable 7d. The attachments 7a, 7b, 7c and 7d serve, for example, to control and/or move the tool slide. Thus, for example, the trailing cable 7d supplies the drive of the tool slide with power and contains the requisite control lines for controlling the drive of the tool slide.

The moving machine element 4, which is in the form of the tool slide in the exemplary embodiment, must firstly be capable of being positioned in a highly precise manner along the crosspiece 6 and must secondly be capable of being traversed in a highly dynamic manner. During highly dynamic traverse operations, high acceleration forces occur, which have to be built up quickly, which necessitates a correspondingly pronounced jolt. Essentially two problems occur here.

The mechanical connection of the attachments to the moving machine element must be designed for the high gradient of the loads associated with the acceleration forces. This may involve considerable complexity and high costs.

Even if the connection of the attachments to the moving machine element is designed in such a way that the attachments withstand the loads, the latter nonetheless react with poorly damped vibratory movements. Vibrations are excited in the attachments due to the dynamic movement of the machine element. These vibrations react on the moving machine element in such a way as to considerably reduce the positioning accuracy of the moving machine element.

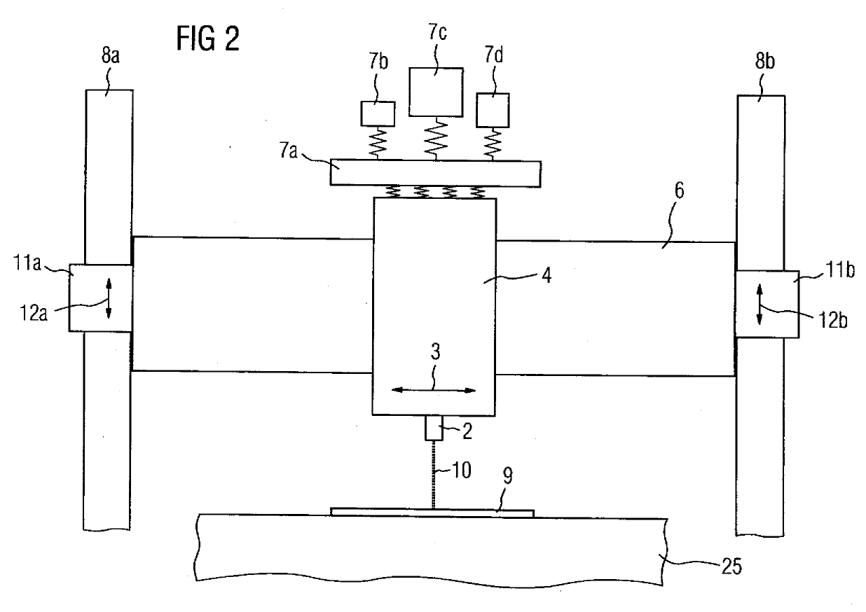

The vibratory effect of the attachments on the moving machine element 4, which is in the form of a tool slide in the exemplary embodiment, is shown schematically in FIG. 2. The vibration behavior is indicated in FIG. 2 by symbolically illustrated springs, the effective direction of the symbolically illustrated springs being in the direction of the double arrow 3. The attachments 7b, 7c and 7d each vibrate essentially with their respectively associated natural frequency in the direction of the double arrow 3. Accordingly, the attachment 7a, which is designed in the form of a support plate in the exemplary embodiment, vibrates with a plurality of frequencies in the direction of the double arrow 3. The designations of the other elements in FIG. 2 correspond to the designations of the elements in FIG. 1.

European Laid-Open Specification EP 1 347 337 A2 has disclosed a positioning system having a damping device.

German Laid-Open Specification DE 40 01 981 A1 has disclosed a coordinate measuring device, wherein, in order to reduce vibrations of the free end of a measuring arm of the coordinate measuring device, to which a sensing head is fastened, an additional weight is movably suspended on the measuring arm.

German Laid-Open Specification DE 103 35 621 A1 has disclosed a device for piezoelectric vibration control in machines in the printing industry.

In commercially available machines, the above problems lead to a restriction in the machine dynamics.

The object of the invention is therefore to provide a simple device for decoupling an attachment from a moving machine element.

The object is achieved by a device for decoupling an attachment from a moving machine element of a machine tool, a production machine or a robot, wherein, in order to carry out the decoupling, the attachment is connected to the machine element via a damping device, wherein the damping device has an eddy current brake and a stiffening element, wherein the eddy current brake has a magnet and an eddy current plate, wherein eddy currents are generated in the eddy current plate by a motion action of the eddy current plate relative to the magnet, wherein the eddy current plate is realized in the form of a plate provided with grooves, wherein a grid made of a material having a high electrical conductivity is arranged in the grooves for the short-circuiting of the eddy currents.

A first advantageous design of the invention is characterized in that the machine element is designed as a tool slide. A design of the machine element as a tool slide constitutes a commercially available design of the machine element.

Furthermore, it proves to be advantageous if the attachment is designed as a trailing cable assembly, a hydraulic component, a support plate or a valve. A design of the attachment as a trailing cable assembly, a hydraulic component, a support plate or a valve constitutes a conventional design of the attachment.

Furthermore, it proves to be advantageous if the damping device has an eddy current brake and a stiffening element, since especially effective damping of the vibrations of the attachments can then be achieved.

Furthermore, it proves to be advantageous if the stiffening element is designed as a spring element, since a design of the stiffening element as a spring element is especially cost-effective.

Furthermore, it proves to be advantageous if the eddy current brake has a magnet and an eddy current plate, wherein eddy currents are generated in the eddy current plate by a motion action of the eddy current plate relative to the magnet. As a result, an eddy current brake is realized in an especially simple manner.

Furthermore, it proves to be advantageous if the eddy current plate is realized in the form of a plate provided with grooves, wherein a grid made of a material having a high electrical conductivity is arranged in the grooves for the short-circuiting of the eddy currents, since the eddy currents then become especially high, which results in very good damping of the vibrations.

Furthermore, it proves to be advantageous if the damping device is designed in the form of a shock absorber, since a shock absorber constitutes a commercially available damping device which can be realized in an especially simple manner.

Furthermore, it proves to be advantageous if the damping device is designed in the form of piezoelectric bending elements, since good damping can be achieved through the use of piezoelectric bending elements.

Three exemplary embodiments of the invention are shown in the drawing and are explained in more detail below. In the drawing:

FIG. 1 shows a commercially available machine tool,

FIG. 2 shows the basic vibration behavior of attachments,

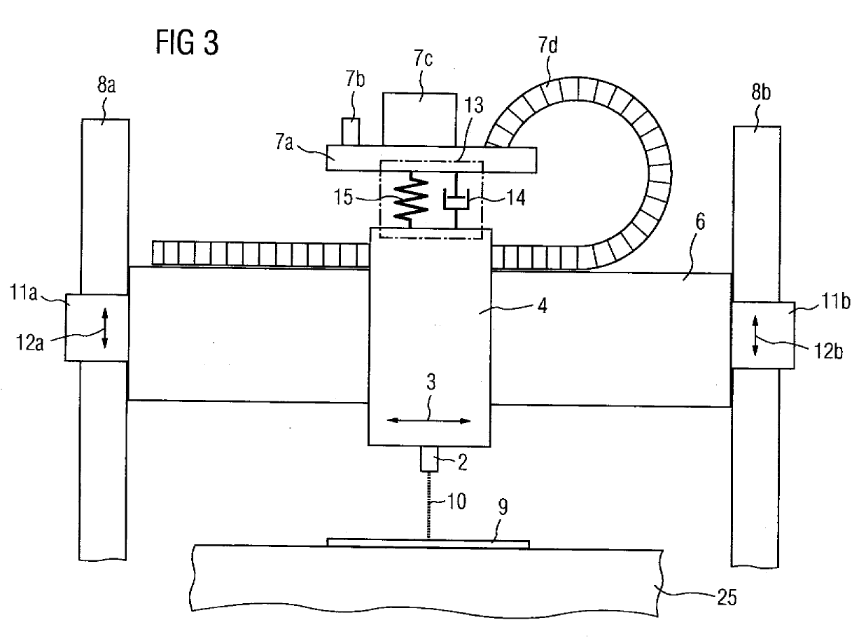

FIG. 3 shows an illustration of the principle of the device according to the invention,

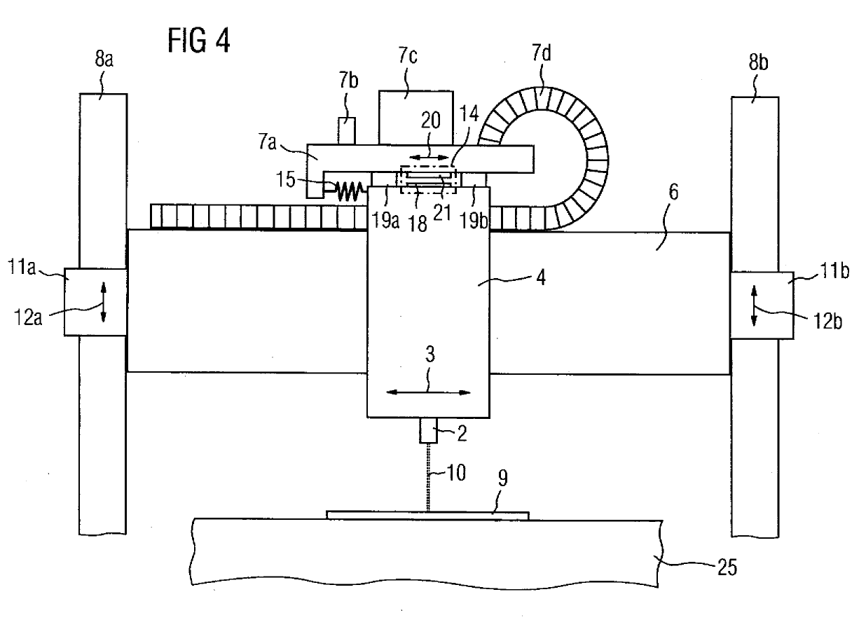

FIG. 4 shows a first exemplary embodiment of the device according to the invention,

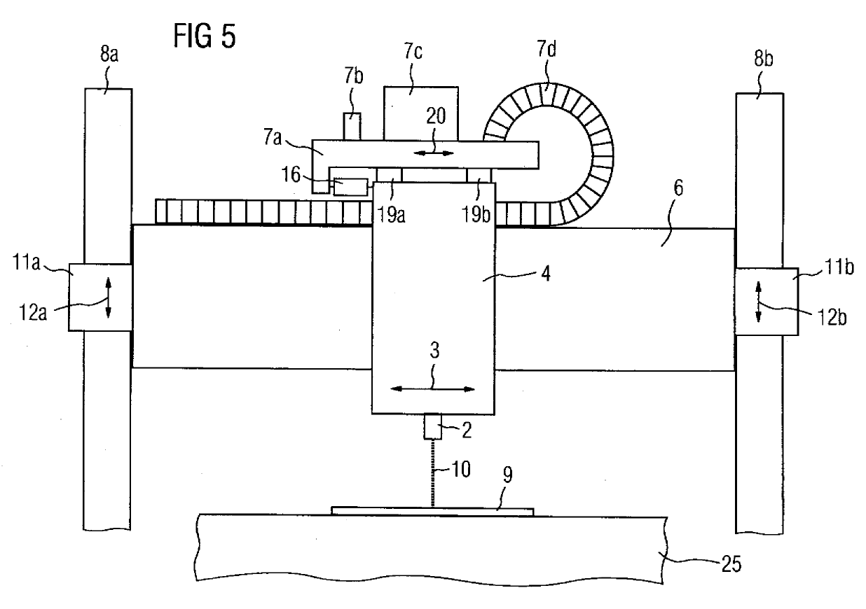

FIG. 5 shows a second exemplary embodiment of the device according to the invention,

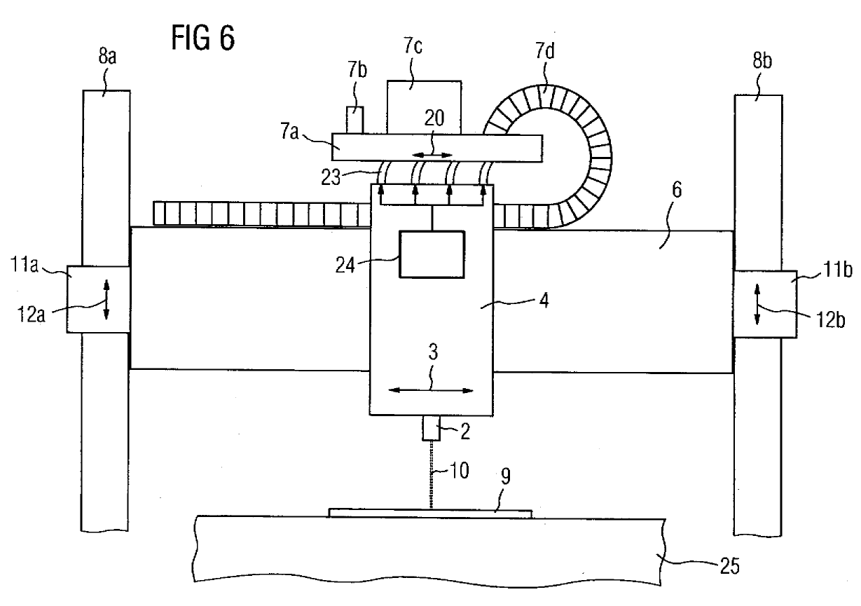

FIG. 6 shows a third exemplary embodiment of the device according to the invention,

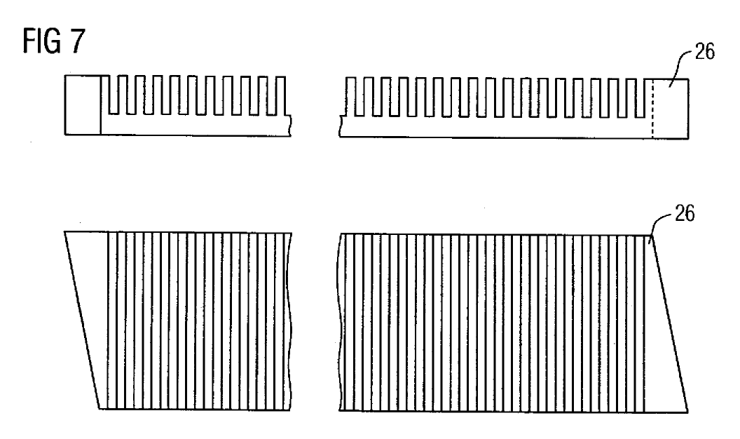

FIG. 7 shows a plate provided with grooves, and

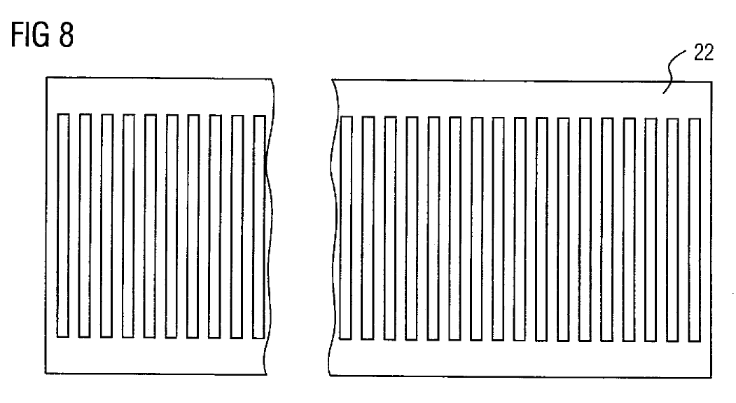

FIG. 8 shows a grid.

The principle of the device according to the invention for decoupling an attachment from a moving machine element is shown in FIG. 3. In FIG. 3, the same elements are provided with the same designations as in FIG. 1. The inventive idea is to no longer connect the attachments 7a, 7b, 7c and 7d, which are connected to one another, rigidly to the moving machine element 4, which is in the form of a tool slide in the exemplary embodiment, but rather, in order to decouple the attachments 7a, 7b, 7c and 7d from the moving machine element, to connect the attachments directly or indirectly to the machine element 4 via a damping device 13. In this case, the damping device 13, in order to dampen the movement, has a damping element 14 and, in order to realize the requisite stiffness of the arrangement, a stiffening element 15, which is shown in the form of a spring element 15 in the diagrammatic illustration according to FIG. 3. The effective direction of the symbolically illustrated damping element 14 and of the symbolically illustrated stiffening element 15 lies in the direction of the double arrow 3.

A first exemplary embodiment of the device according to the invention is shown in FIG. 4. The embodiment shown in FIG. 4 corresponds essentially to the embodiment described above with respect to FIG. 1. In FIG. 4, therefore, the same elements are provided with the same designations as in FIG. 1. The essential difference from the embodiment according to FIG. 1 consists in the fact that, in the embodiment according to FIG. 4, in order to decouple the attachments 7a, 7b, 7c and 7d from the moving machine element 4, the attachments 7a, 7b, 7c and 7d are connected to the machine element 4 directly or indirectly via the damping device, which in the exemplary embodiment is in the form of a combination of a damping element 14 and a spring element 15. In the exemplary embodiment, in order to carry out the decoupling, the attachment 7a, which in the exemplary embodiment is in the form of a support plate, is connected via a damping device to the machine element 4, which in the exemplary embodiment is designed in the form of a tool slide. The attachments 7b, 7c and 7d are connected to the support plate 7a. In the exemplary embodiment, the damping element 14 is realized in the form of an eddy current brake. A commercially available spring, for example, may serve as spring element 15. The spring element 15, as a component of the damping device, provides for the requisite stiffness between the attachments 7a, 7b, 7c and 7d and the machine element 4. The attachments 7a, 7b, 7c and 7d are movably mounted on the machine element 4 in both directions of the double arrow 20 via two guides 19a and 19b. A magnet 18 attached to the machine element 4 produces a magnetic field which passes through an eddy current plate 21. Eddy currents are generated in the eddy current plate 21 by a motional action of the eddy current plate 21 relative to the magnet 18, and these eddy currents dampen a movement of the attachments 7a, 7b, 7c and 7d in both directions of the double arrow 20.

The magnet 18 together with the eddy current plate 21 forms an eddy current brake. By means of the eddy current brake, high damping of the vibrations of the attachments 7a, 7b, 7c and 7d can be achieved, which makes possible greater positioning accuracy of the machine element 4 and highly dynamic motional guidance of the machine element 4. Of course, the magnet 18 may in this case be composed of a plurality of individual magnets and/or have a plurality of differently magnetized regions.

An advantageous embodiment of the eddy current plate 21 is shown in FIG. 7 in a side view (top illustration) and in a plan view (bottom illustration). In this case, the eddy current plate 21 is realized in the form of a plate 26 provided with grooves, wherein a grid 22 made of a material having a high electrical conductivity is arranged in the grooves for the short-circuiting of the eddy currents. The grid 22 is shown in a plan view in FIG. 8, the grid 22, which is inserted into the grooves of the plate 26, preferably being made of copper, whereas the plate 26 is made of a magnetically conductive material. Due to the grid being formed with a material having a high electrical conductivity, the eddy currents reach an especially high value, such that especially good damping of the vibrations of the attachments is obtained.

A further embodiment of the device according to the invention is shown in FIG. 5. The embodiment shown in FIG. 5 corresponds essentially to the embodiment described with respect to FIG. 4. In FIG. 5, therefore, the same elements are provided with the same designations as in FIG. 4. The essential difference of the embodiment according to FIG. 5 from the embodiment according to FIG. 4 consists in the fact that, in the embodiment according to FIG. 5, the damping device is not formed by a combination of an eddy current brake and a stiffening element, but rather is designed in the form of a shock absorber 16 which connects the attachment 7a to the machine element 4. The shock absorber 16, which may be constructed, for example, as a hydraulic component obtainable commercially, can realize both the requisite stiffness and the damping within a single element.

A further exemplary embodiment of the device according to the invention is shown in FIG. 6. The embodiment shown in FIG. 6 corresponds essentially to the embodiment described with respect to FIG. 4. In FIG. 6, therefore, the same elements are provided with the same designations as in FIG. 1. The essential difference of the embodiment according to FIG. 6 from the embodiment according to FIG. 4 consists in the fact that, in the embodiment according to FIG. 6, in order to decouple the attachments 7a, 7b, 7c and 7d from the moving machine element 4, the attachments 7a, 7b, 7c and 7d are connected to the machine element 4 directly or indirectly via a damping device which is in the form of piezoelectric bending elements in the embodiment according to FIG. 6. For the sake of clarity, only a single piezoelectric bending element 23 is provided with a designation in FIG. 6.

By means of the piezoelectric bending elements, both the requisite stiffness and the damping can be realized within a single element. The piezoelectric bending elements can be bent in both directions of the double arrow 20 in an electronically controlled manner by appropriate activation of said piezoelectric bending elements. By suitable activation of the piezoelectric bending elements in opposition to the instantaneous vibration direction of the attachments 7a, 7b, 7c and 7d, high damping of the vibrations of the attachments 7a, 7b, 7c and 7d can be achieved.

For this purpose, the piezoelectric bending elements are appropriately activated by means of a controller 24, the controller 24 being an integral component of the moving machine element 4 in the exemplary embodiment according to FIG. 6. Of course, the controller 24 may also be arranged outside the machine element 4.

The decoupling according to the invention of the attachments from the moving machine element has numerous advantages. Thus, decoupling of all the attachments within a wide frequency range can be realized by the device according to the invention. The reactions of attachments on a moving machine element, such as a tool slide for example, can be greatly reduced. As a result, firstly a greater positioning accuracy of the moving machine element is achieved and secondly moving machine elements of machine tools, production machines or robots can be traversed with greater dynamics compared with commercially available machines. At the same time, the attachments are stressed to a substantially lower degree by acceleration forces compared with commercially available machine tools, production machines or robots, since the forces transmitted to the attachments are built up and reduced very gently by the damping device, such that the attachments are protected.

1. A device for decoupling an attachment from a moving machine element (4) of a machine tool, a production machine or a robot, said device comprising a damping device via which the attachment is connected to a machine element, said damping device including:
an eddy current brake having a magnet and an eddy current plate, with eddy currents generated in the eddy current plate as the eddy current plate moves relative to the magnet, wherein the eddy current plate is realized in the form of a plate provided with grooves, and
a grid made of a material having a high electrical conductivity and arranged in the grooves for the short-circuiting of the eddy currents.

2. The device of claim 1, wherein the machine element is designed as a tool slide.

3. The device of claim 1, wherein the attachment is designed as a member selected from the group consisting of a trailing cable assembly, a hydraulic component, a support plate, and a valve.

4. The device of claim 5, wherein the stiffening element is designed as a spring element.

5. The device of claim 1, wherein the damping device includes a stiffening element for providing stiffness between the attachment and the machine element.
